(19) United States
(12) Patent Application Publication
(10) Pub. No.: US 2010/0080217 A1
(43) Pub. Date: Apr. 1, 2010

(54) Sip Telephone System and Method for Controlling Line Key Display

(75) Inventor: Yoichi Naito, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/550,203

(22) Filed: Aug. 28, 2009

(30) Foreign Application Priority Data
Sep. 26, 2008 (JP) 2008-248663

(51) Int. Cl. H04L 12/66

(52) U.S. Cl. 370/352

(57) ABSTRACT

According to one embodiment, a SIP telephone system includes a plurality of terminals each configured to include a plurality line keys configured to blink or light and distinguish a plurality of lines, and an SIP server apparatus configured to house the plurality of terminals and be connected to a communication network, and establish communication among the terminals via a selected line in a case where an arbitrary line key is selected from among the plurality of line keys by the terminals, wherein the SIP server apparatus includes a transmitter which adds each item of identification information of the plurality of line keys to be selection candidates to a control message, to transmit the identification information to the terminals, and each of the terminals includes a controller which blinks or lights the corresponding-line key among the plurality of line keys based on the identification information.

### CROSS-REFERENCE TO RELATED APPLICATIONS

This application is based upon and claims the benefit of priority from Japanese Patent Application No. 2008-248663, filed Sep. 26, 2008, the entire contents of which are incorporated herein by reference.

### BACKGROUND

1. Field

One embodiment of the invention relates to a Session Initiation Protocol (SIP) telephone system having a communication function according to SIP, and relates to a method for controlling a line key display so as to blink or light a plurality of line keys of a terminal in the SIP telephone system.

2. Description of the Related Art

In recent years, an IP telephone system for interactively transmitting/receiving images and audio in real time as packet data via an Internet protocol (IP) network has become widely used. The IP telephone system may perform extension communication and trunk outgoing call/incoming call among main apparatuses via the IP network as well as may perform inter-extension communication and trunk outgoing call/incoming call for each main apparatus connected to the IP network. In this IP telephone system, SIP has been widely used as its protocol.

Meanwhile, also in the SIP telephone system, a system, which may select an arbitrary line key from among a plurality of line keys such as extension keys and CO keys on a terminal side for receiving an incoming call in the same way as that of a conventional key telephone system, has been strongly desired.

As regards a related technique of this kind, a method, comparing coincident between termination numbers included in an “INVITE” message of SIP and telephone numbers in a storage device to light on a lamp for showing call termination if those numbers coincide with each other, has been proposed (e.g., Jpn. Pat. Appln. KOKAI Publication No. 2006-333307).

However, when selecting the extension key and the CO key on a terminal side in call termination, the SIP telephone system of the given has to transmit a message for specifying the extension key and a message for specifying the CO key from an SIP server apparatus to a terminal. This situation becomes remarkable as the number of line keys configured to select and specify in the call termination increases, the resulting state poses a disagreeable problem.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view depicting an embodiment of an SIP telephone system for supporting a method for controlling a line key display of the invention;

FIG. 2 is an exemplary block diagram depicting a functional configuration of an SIP server and a telephone terminal shown in FIG. 1;

FIG. 3 is an exemplary view depicting an example of trunk related information for use in the SIP server;

FIG. 4 is an exemplary view depicting an example of a call termination determination table for use in the telephone terminal;

FIG. 5 is an exemplary sequence view depicting an example of a method for displaying a call termination which has been conventionally performed;

FIG. 6 is an exemplary sequence view depicting an example of a method for displaying a call termination of the embodiment;

FIG. 7 is an exemplary sequence view depicting another example of the method for displaying the call termination of the embodiment;

FIG. 8 is an exemplary sequence view in a case in which call termination has posed a problem previously;

FIG. 9 is an exemplary sequence view depicting a measures method in the embodiment;

FIG. 10 is an exemplary sequence view depicting an example for displaying call termination on a plurality of line keys according to a current SIP standard;

FIG. 11 is an exemplary sequence view depicting an example for displaying call termination on a plurality of line keys in the embodiment;

FIG. 12 is an exemplary flowchart depicting a control processing procedure of the SIP server in the embodiment;

FIG. 13 is an exemplary view depicting an example of an “INVITE” message; and

FIG. 14 is an exemplary flowchart depicting a control processing procedure of the telephone terminal in the embodiment.

### DETAILED DESCRIPTION

Various embodiments according to the invention will be described hereinafter with reference to the accompanying drawings. In general, according to one embodiment of the invention, a Session Initiation Protocol (SIP) telephone system, comprising: a plurality of terminals each configured to include a plurality line keys configured to blink or light and distinguish a plurality of lines; and a SIP server apparatus configured to house the plurality of terminals and be connected to a communication network, and establish communication among the terminals via a selected line in a case where an arbitrary line key is selected from among the plurality of line keys by the terminals, when communication establishment requests to the terminals are made, wherein the SIP server apparatus comprises: a transmitter which adds each item of identification information of the plurality of line keys to be selection candidates to a control message, to transmit the identification information to the terminals, when the communication establishment requests are made to the terminals, and each of the terminals comprises: a controller which blinks or lights the corresponding-line key among the plurality of line keys based on the identification information, when each item of identification information of the plurality of line keys is added to the control message transmitted from the SIP server apparatus.

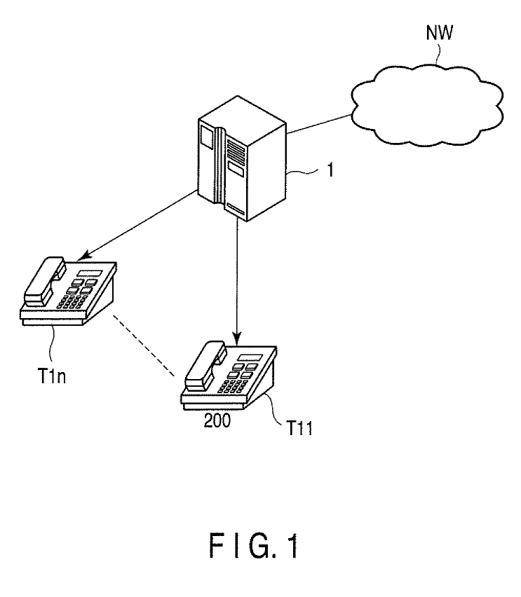

FIG. 1 shows a schematic configuration view depicting an embodiment of an SIP telephone system for supporting a method for controlling a line key display of the invention.

This system includes an SIP server 1. A plurality of telephone terminals T11 (telephone number 200) to T1n (n is a natural number) are connected to the SIP server 1. A public network NW is connected to the SIP server 1.

That is, the SIP server 1 has a usual exchange control function regarding mutual call origination and call termination inter-telephone terminal T11-T1n, and among the public network NW and the telephone terminals T11-T1n.

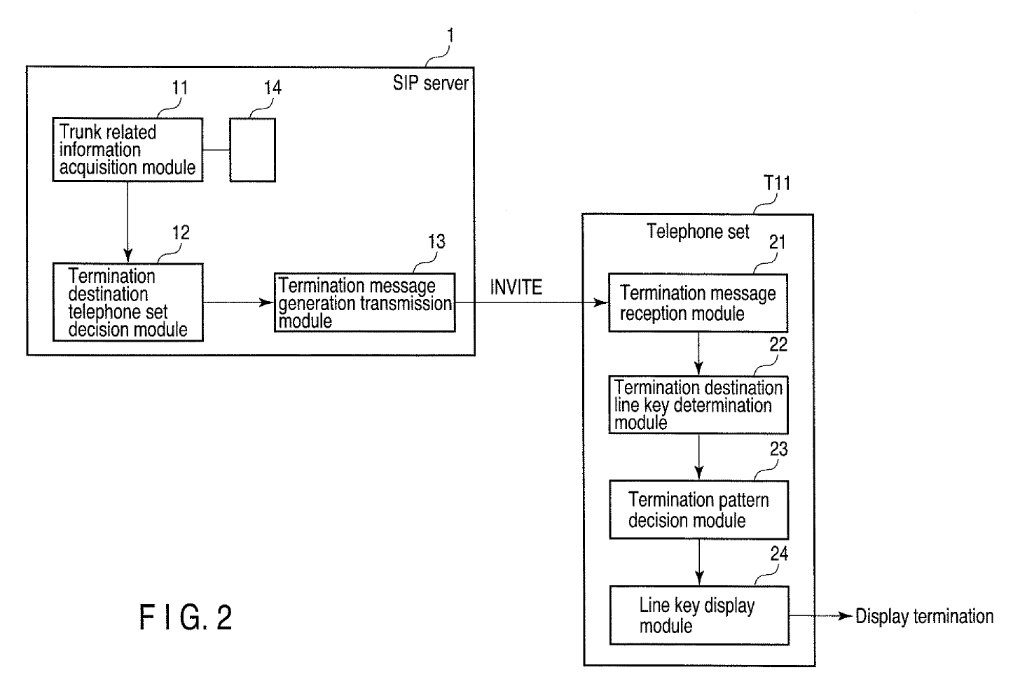

FIG. 2 shows a block diagram depicting a functional configuration of the SIP server 1 and the telephone terminals T11-T1n. Here, The SIP server 1 and the telephone terminal T11 will be described on behalf of those apparatuses.

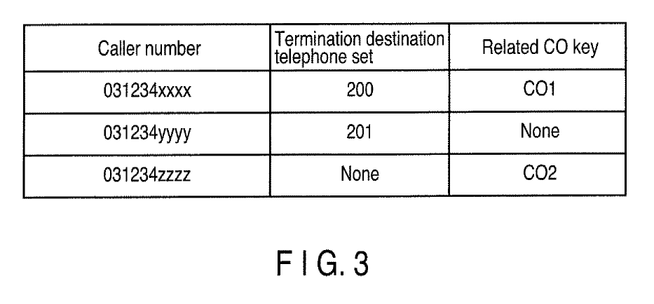

The SIP server 1 comprises a trunk related information acquisition module 11 (acquisition module 11), a termination destination telephone set decision module 12 (decision module 12), and a call termination message generation transmission module 13 (transmission module 13). When an incoming call is terminated from a trunk, the acquisition module 11 acquires trunk related information from a storage module 14 shown in FIG. 3. This trunk related information is a table showing correspondence relationships among caller numbers, telephone numbers of termination destinations, and related CO keys.

The decision module 12 decides a line key to be a termination destination based on the trunk related information acquired through the acquisition module 11. Here, in a case in which a caller number “031234xxxx” is included in an incoming call, the decision module 12 decides identification information “200” of the line key and identification information “CO1” of the CO key. The transmission module 13 inserts the identification information “200” of the line key and identification information “CO1” of the CO key decided by means of the decision module 12 into an extended information area of the “INVITE” message to transmit the identification information “200” and “CO1” to the telephone terminal T11 to be the termination destination.

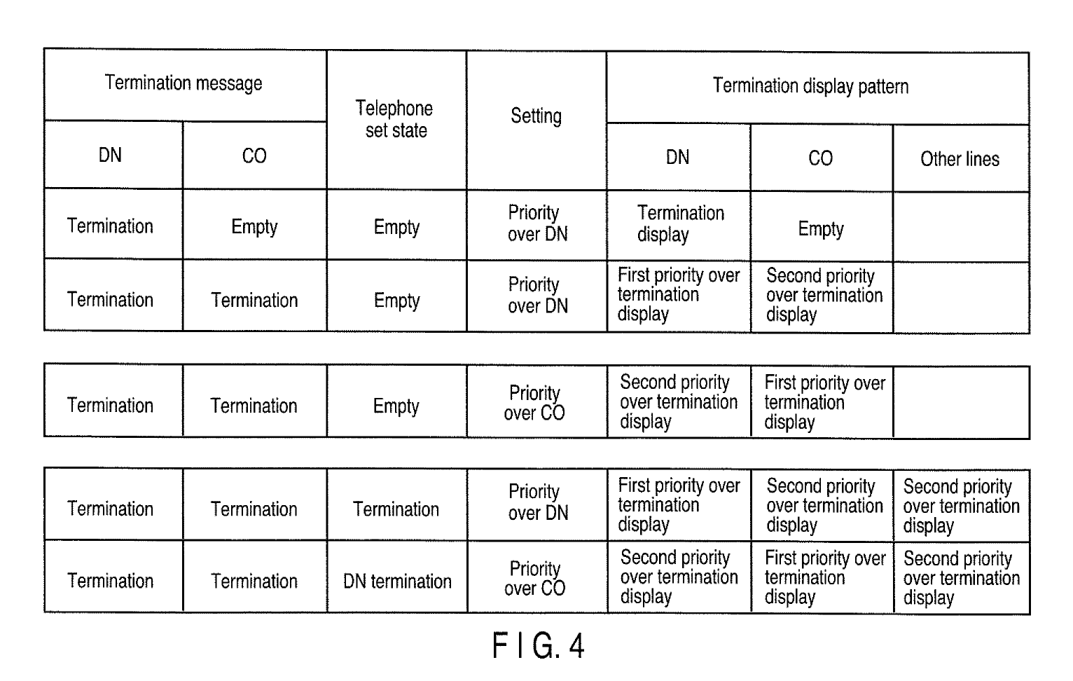

Meanwhile, the telephone terminal T11 includes a message reception module 21, a termination destination line key determination module 22 (determination module 22), a termination pattern decision module 23 (decision module 23), and a line key display module 24 (display module 24). The reception module 21 receives the “INVITE” message from the SIP server 1. The determination module 22 analyzes content the “INVITE” message to be a call termination message to acquire identification information of a line key desiring to display its termination thereon in accordance with the analysis result shown in FIG. 4.

The decision module 23 decides a state to be displayed in accordance with call termination of this time from a current telephone state (call termination state, speech state) of the current telephone set and a kind of a line of the required termination destination line key.

The display module 24 lights or blinks an LED of a corresponding-line key. When the order of priority “1” is given to the identification information “200” of the line key, and when the order of priority “2” is given to the identification information “CO1” of the CO key, the display module 24 blinks, for example, the identification information of the line key “200” at short time intervals and the CO key “CO1” at long time intervals.

The following will describe operation of the configuration of the above.

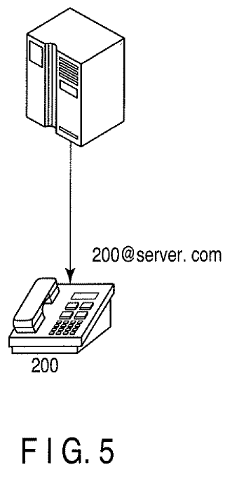

FIG. 5 shows a conventional call termination display method.

Products of SIPs are commercialized by a large number of manufactures as the IP telephone standard. SIP is the standard of a computer based on Hyper Text Transport Protocol (HTTP) composed of the WEB, the range of the defined standard is too narrow to provide all functions of a telephone set which has been used conventionally. For instance, there is no problem to provide a service equivalent to a service provided from a general public network; however, each manufacturer has independently provided a feature of a private branch exchange (PBX) such as hold and transfer in an early period (at a later time, the future has been worked out through Request for Comments [RFC]).

Meanwhile, SIP has not assumed a configuration having a large number of line keys that are a feature of key telephone apparatus providing an in-enterprise communication system, and then, each enterprise used to achieve the configuration through its proprietary extension. Therefore, as regards the extension key and the CO line key to be frequently used for a key telephone set, if the extension is set as a termination destination from the trunk and CO line key is set as trunk related information, a control system of SIP defined in the current RFC may not control, through one message, the termination indicated on two line keys. If the SIP telephone system still uses the present control system, the SIP server should virtually define a User Agent (UA) for each line key of one telephone set, and transmits the number of call termination messages of necessary line keys.

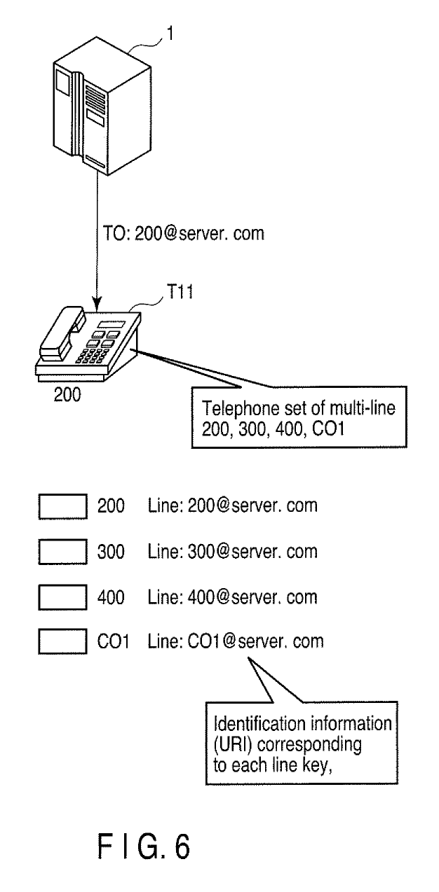

Then, in the embodiment, as shown in FIG. 6, the method for the call termination display firstly extends the massage according to SIP, and provides a means for specifying a line targeted by the message. For instance, the method adds a header, or adds a parameter to a body part.

The header or the parameter specifies the identification information of a target line key. The identification information may be a URI, a number or and a character string, and the identification information may be decided by means of the SIP server 1 and the telephone terminal T11 (or an end point).

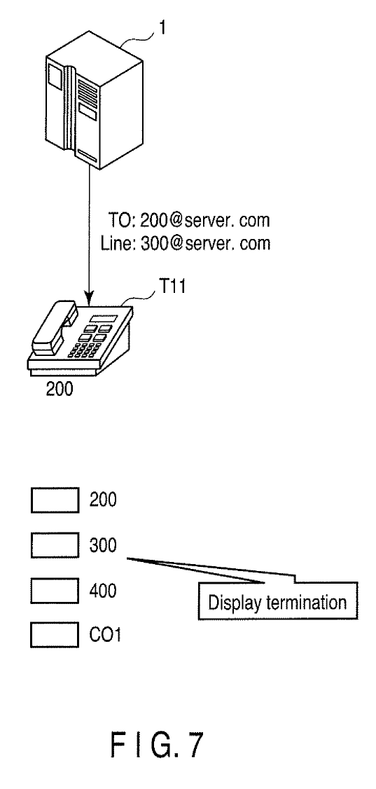

In the embodiment, as shown in FIG. 7, in the call termination, the telephone terminal T11 displays (e.g., blinks) to report the call termination to the line key corresponding to the specified information.

For instance, in a case which specifies the line key of “300” on the telephone terminal T11 (telephone number 200); the method for the call termination display reports to the terminal T11 as follows:
To: 200@server. com
Line: 300@server. com.

Specifying the line key in such a way controls the corresponding-line key (however; inscriptions of “To” and “Line” are merely examples, and other inscriptions may be allowed).

In call origination, the telephone terminal T11 puts the above mentioned information corresponding to the line key in use on the specified information to the server 1. If it is desired to control a plurality of line keys at the same time, the telephone terminal T11 puts a plurality of “Line” parameters on the message then transmits the message.

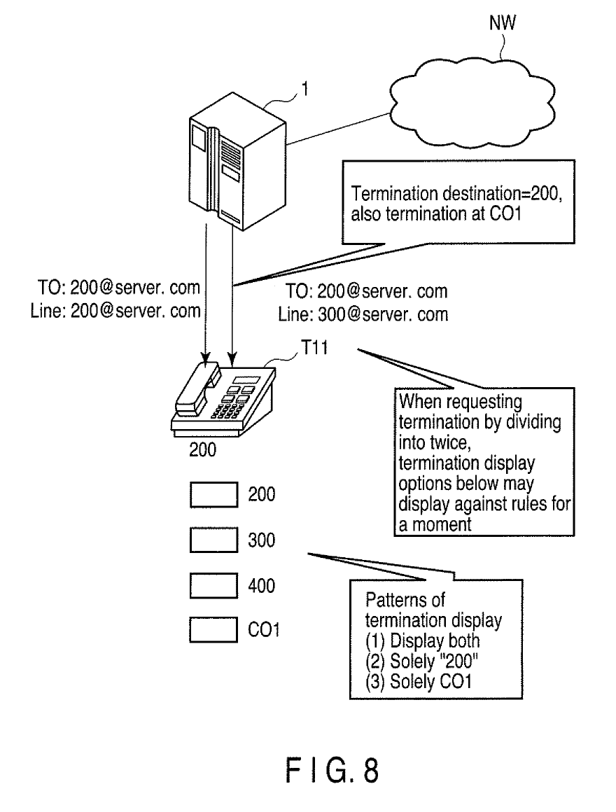

FIG. 8 shows a case in which a problem is posed in call termination.

In call termination, there is a case in which a line key indicating the trunk and a line key indicating the extension simultaneously display call termination.

For instance, there is a case in which a terminal of a DN “200” is set at a termination destination from the trunk and also the trunk is associated with the key of the CO1. In this case, when an incoming call reaches the trunk, in the convention PBX and key telephone set, a key indicating a line “200” of identification information of the DN “200” and a key of the CO1 are blinked at the same time. In this case, such specifications, which have to change a display pattern of each key depending on kinds of line keys indicating the simultaneous call termination, pose a problem.

The SIP standard cannot perform such a change. Usually, even in a case of proprietary extension, the method for the call termination display has not been able to control call termination display of a plurality of line keys at the same time. Therefore, it is needed to independently transmit the call destination of the identification information “200” and “CO1”.

At this moment, in a case where the extension key and the CO key display the call termination at the same time, it is assumed that setting makes options as follows:
(1) Both the extension key and the CO key indicate call termination
(2) Solely the extension key indicates call termination
(3) Solely the CO key indicates call termination.

In this assumed case, the conventional method has to provide information from an SIP server 1. Since the conventional method transmits the message by diving into to times, the display may be changed for a moment because of a small time difference, and the resulting change makes a user have a feeling of strange.

In a case where another call termination is made and the call termination display of the identification information “200” and “CO1” are decided together with another call termination, the SIP server 1 frequently decides the call termination of the above, and the resulting decision loads heavy processing on the SIP server 1.

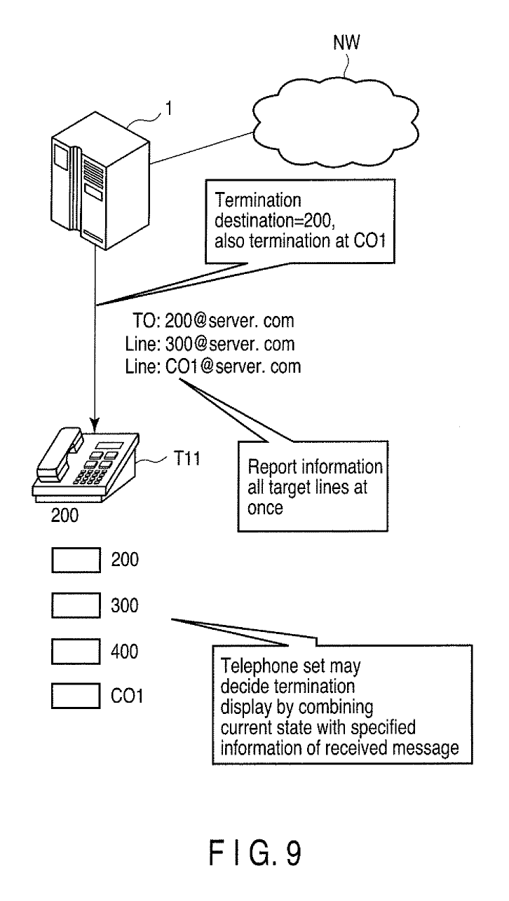

Therefore, in the embodiment, as shown in FIG. 9, the telephone terminal T11 recognizes the state of the line key indicating the call termination, the SIP server 1 only reports the information of the call termination, and the telephone terminal T11 decides a display pattern. At this moment, to reduce the time difference in call termination information between the identification information “200” and the identification information “CO1”, the telephone terminal T11 puts a plurality of items of the call termination information, namely, the information showing the call termination for the identification information “200”, “CO1” on one message for a report.

Reporting through one message may avoid a problem of a transitional display. The conventional system needs to transmit a plurality of SIP messages, the resulting transmission increases resources (memory, CPU power) required by software such as an SIP stack. Since this embodiment can report through the one message, the increase in resource can be suppressed.

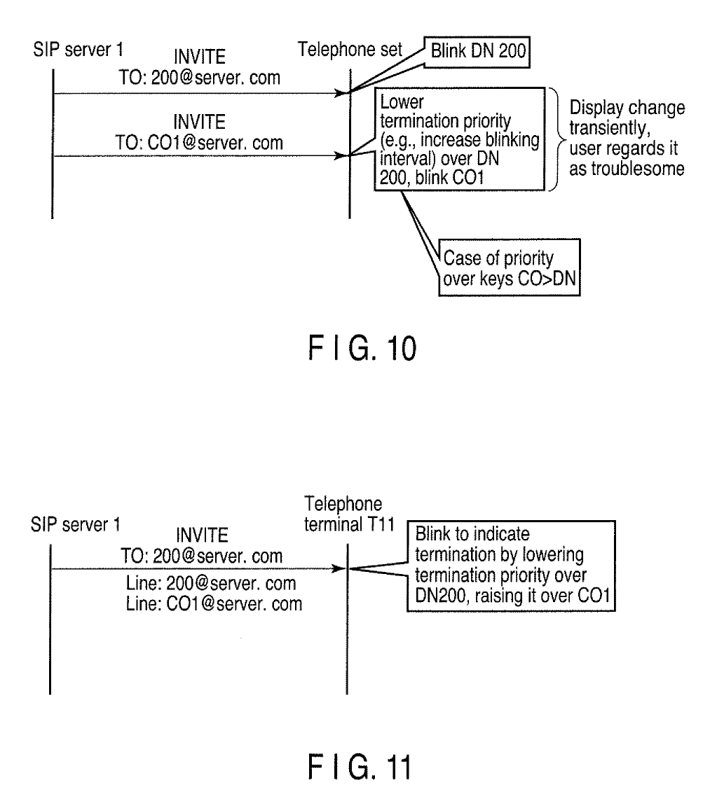

FIG. 10 shows a sequence depicting an example in which a plurality of line keys indicates the call termination in the current SIP standard.

Conventionally, since the SIP telephone system receives incoming calls by dividing them into twice, in a case the display pattern is decided according to the second call termination message, the telephone terminal T11 displays a pattern which is different from the display pattern to be originally displayed in accordance with specifications, the resulting display pattern may trouble the user.

Therefore, in the embodiment, as shown in FIG. 11, since the final display pattern is decided according to one message, the system may provide a consistent service to the user.

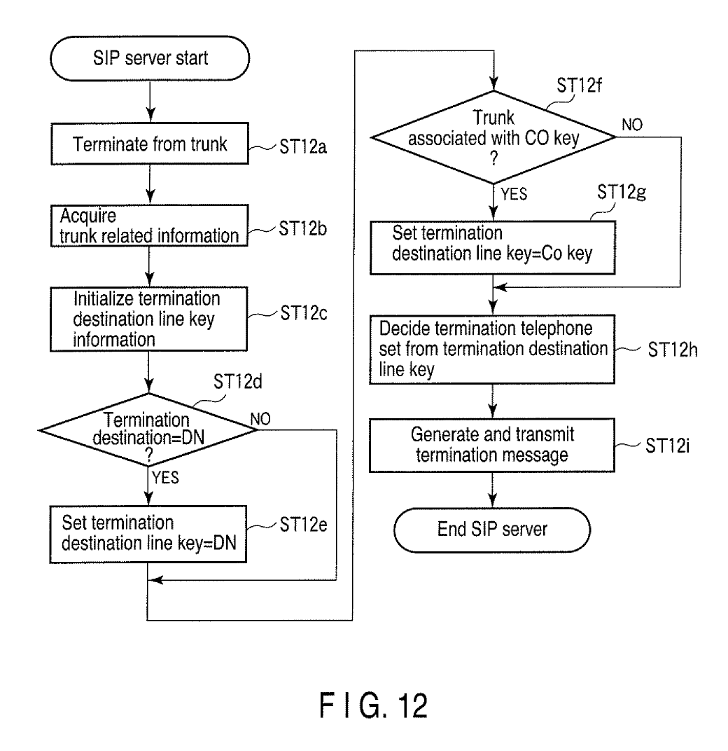

FIG. 12 is a flowchart illustrating the control processing procedure of the SIP server 1.

When an incoming call reaches from the trunk, the SIP server 1 firstly shifts the state from Block ST12a to Block ST12b, and there, the acquisition module 11 acquires the information associated with the trunk through which a call has been terminated. The SIP server 1 then initializes termination destination line key information (Block ST12c) to determine whether or not the termination destination is the DN (Block ST12d).

Here, if a caller number is “031234xxxx” and an termination destination is specified to “200” in accordance with the trunk related information (YES, Block ST12d), the SIP server 1 sets the termination destination line key to the DN “200” (Block ST12e), and then, determines whether or not the trunk is associated with the CO key (Block ST12f).

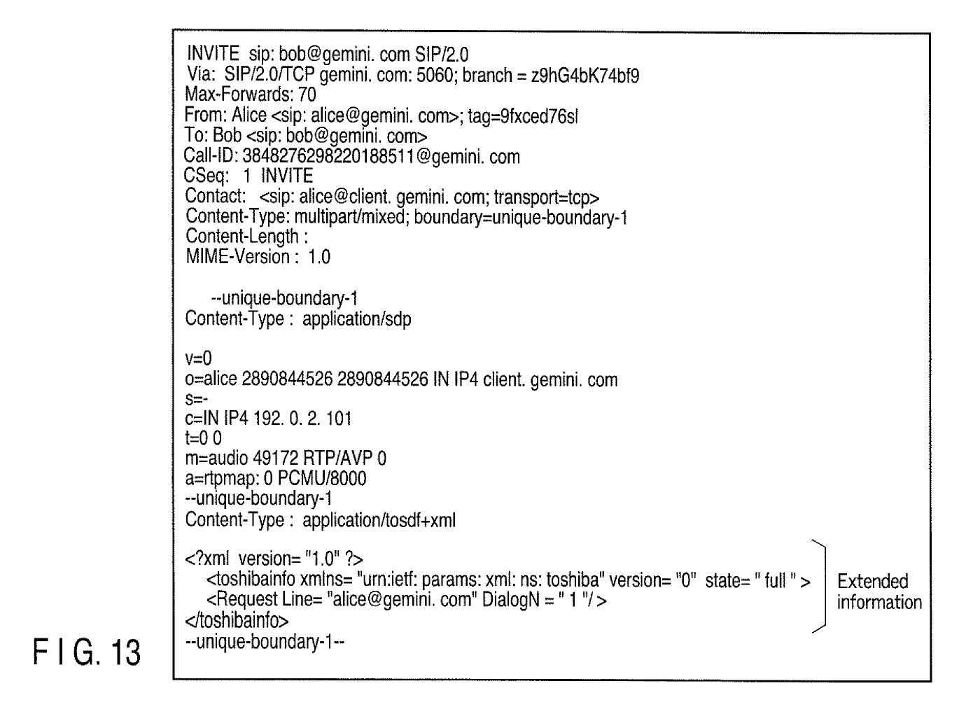

If the caller number is “031234xxx” and the trunk is associated with the CO key in accordance with the trunk related information (YES, Block ST12f), the SIP server 1 sets the termination destination line key to the CO “CO1” (Block ST12g) to decide that the telephone terminal T11 corresponding to the DN “200” as the termination destination depending on the termination destination line key (Block ST12h). For instance, the SIP server 1 inserts the DN “200”, the CO “CO1” into the extended information area of the “INVITE” message shown in FIG. 13 to transmit the “INVITE” message to the telephone terminal T11 (Block ST12i).

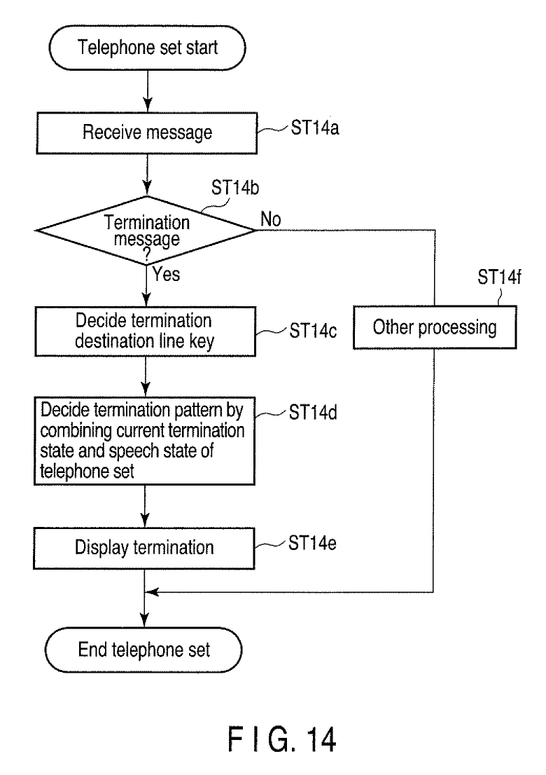

Meanwhile, FIG. 14 shows a flowchart illustrating the control processing procedure of the telephone terminal T11.

The telephone terminal T11 receives a message through the message reception module 21 (Block ST14a), and determines whether or not the received message is the call termination message, for example, the “INVITE” message (Block ST14b).

Here, if the received massage is determined to be the termination message (YES, Block ST14b), the telephone terminal T11 analyzes the content of the received message through the determination module 22 to acquire the identification information of the line key through which the call termination is displayed (Block ST14c).

The telephone terminal T11 then decides a state to be displayed by means of the decision module 23 through the call termination of this time in accordance with the state (termination state and speech state) of the current telephone set and the line kind of the termination destination line key desired to be displayed for indicating the call termination (Block ST14d). Not only the termination destination line key of this time but also the state of the line key during speech or during call termination become targets of an changed if necessary.

The telephone terminal T11 actually displays the termination through the line key display module 24 (Block ST14e). For instance, the telephone terminal T11 displays the blinking pattern of an LED and makes a termination tone becomes a target.

If it is determined that the received message is not the termination message (NO, Block ST14b), the telephone terminal T11 executes another processing (Block ST14f).

As described above, in the embodiment, the SIP server 1 inserts each item of the identification information of the plurality of line keys to be selection candidates into the extended information area of the control message such as the “INVITE” message to be transmitted to the telephone terminals T11-T1n in the call termination then transmits the control message to the telephone terminal T11 to be the termination destination. The telephone terminal T11 lights or blinks the corresponding-line key.

Thus, the SIP telephone system may select an arbitrary line key from among a plurality of line keys blinking or lighting on the telephone terminal T11 side to establish communication only by one time transmission of the control message without an exchange of complicated messages between the SIP server 1 and the telephone terminal T11 to be the termination destination.

While the aforementioned embodiment has been described the example in which the SIP telephone system utilizes the extended information area of the “INVITE” message to report the identification information of the plurality of line keys to the telephone terminal T11, the identification information may be put on the information existed in other than the extended information area.

In the foregoing embodiment, the SIP server 1 may give each priority to each of the plurality of the line keys. In this way, the telephone terminal T11 may set so that the blinking pattern or the lighting pattern becomes different from each other for each priority. Thereby, the user can recognize which of the line keys should select by giving top priority based on the displays of the line keys.

Further, the configuration of the SIP telephone system, the functional configuration of the SIP server, the kind of the functional configuration of the telephone terminal, the line key display control procedure and its content, etc., may be embodied in various forms without departing from the spirit or scope of the general inventive concept thereof.

The various modules of the systems described herein can be implemented as software applications, hardware and/or software modules, or components on one or more computers, such as servers.

While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A Session Initiation Protocol (SIP) telephone system, comprising:
a plurality of terminals each configured to include a plurality line keys configured to blink or light and distinguish a plurality of lines; and
a SIP server apparatus configured to house the plurality of terminals and be connected to a communication network, and establish communication among the terminals via a selected line in a case where an arbitrary line key is selected from among the plurality of line keys by the terminals, when communication establishment requests to the terminals are made, wherein
the SIP server apparatus comprises:
a transmitter which adds each item of identification information of the plurality of line keys to be selection candidates to a control message, to transmit the identification information to the terminals, when the communication establishment requests are made to the terminals, and
each of the terminals comprises:
a controller which blinks or lights the corresponding-line key among the plurality of line keys based on the identification information, when each item of identification information of the plurality of line keys is added to the control message transmitted from the SIP server apparatus.

2. The system of claim 1, wherein
the transmitter inserts each identification information of the plurality of line keys to be selection candidates to an extended information area of the control message, to transmit the identification information to the terminals.

3. The system of claim 1, wherein
the transmitter adds each identification information of the plurality of line keys to be selection candidates in the control message together with priority, to transmit the identification information to the terminals; and
the controller makes the corresponding-line key among the plurality of line keys different in blinking pattern or lighting pattern for each of the priority.

4. A method for controlling a line key display for use in a Session Initiation Protocol (SIP) telephone system which comprises a plurality of terminals each including a plurality line keys configured to blink or light; and a SIP server apparatus configured to house the plurality of terminals for distinguishing a plurality of lines and be connected to a communication network, and configured to establish communication among the terminals via a selected line in a case where an arbitrary line key is selected from among the plurality of line keys by the terminals when communication establishment requests to the terminals are made, comprising:
adding to each identification information of plurality of line keys to be selection candidates in a control message to transmit the identification information from the SIP server to the terminals, when the communication establishment requests are made to the terminals; and
blinking or lighting the corresponding-line key among the plurality of line keys based on the identification information when each item of the identification information of the plurality of line keys in the control message transmitted from the SIP server apparatus.
